(19) United States
(12) Patent Application Publication
(10) Pub. No.: US 2006/0009544 A1
(43) Pub. Date: Jan. 12, 2006

(54) Aqueous ink and ink set for ink jet recording

(75) Inventors: Masashi Miyagawa, Yokohama-shi (JP); Junichi Sakai, Tokyo (JP); Yoko Ichinose, Tokyo (JP); Toshiaki Kaneko, Tokyo (JP); Hirofumi Ichinose, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/165,121

(22) Filed: Jun. 24, 2005

(30) Foreign Application Priority Data
Jun. 25, 2004 (JP) 2004-188900 (PAT.

(51) Int. Cl. C09D 11/00; C03C 17/00

(52) U.S. Cl. 523/160; 106/31.6; 106/31.9; 523/161

(57) ABSTRACT

The aqueous ink of the present invention includes: a coloring material, wherein the coloring material is a dispersible colorant comprising a colorant and chargeable resin pseudo fine particles smaller in size than the colorant, and the chargeable resin pseudo fine particles are fixed to the colorant; water; and at least one kind of salt selected from the group consisting of (M1)₂SO₄, CH₃COO(M1), Ph-COO(M1), (M1)NO₃, (M1)Cl, (M1)Br, (M1)I, (M1)₂SO₃, and (M1)CO₃, wherein M1 represents an alkali metal, ammonia, or organic ammonium and Ph represents a phenyl group.

### BACKGROUND OF THE INVENTION

1. Field of the Invention

The present invention relates to an aqueous ink including at least a dispersible colorant suitable for ink jet recording and a salt, and to an ink set for ink jet recording using the aqueous ink.

2. Related Background Art

Heretofore, dyes and pigments have been mainly used as colorants for use in an aqueous ink, out of which water-soluble dyes have been widely used-due to high handling ease and high color developability as an aqueous ink. However, the development of an ink including a substantially water-insoluble colorant, particularly a pigment, as the colorant of an ink for aqueous ink jet recording which can provide higher image having weather resistance and water resistance, is now under way energetically.

To use a water-insoluble colorant, in particular a pigment, as an ink for aqueous ink jet recording, the colorant must be dispersed stably in water. In this case, a surfactant or a polymeric dispersant (may also be called “dispersing resin” hereinafter) has been used to stabilize the dispersion. However, in the case of stably dispersing the pigment by using the dispersant, particularly when recording was carried out on a recording medium such as plain paper having high ink permeability, the ink permeates the inside of the recording paper, so that cellulose on the surface of the recording paper was exposed, or the ink bleeds out along cellulose fibers, whereby character quality and color developability may deteriorated.

To solve the above problems, there is proposed a technique for chemically modifying the surface of the water-insoluble colorant (for example, refer to Japanese Patent Application Laid-Open No. H10-195360). Such a surface-modified pigment is generally called “self-dispersible pigment” and the dispersion stability of the pigment is attained not by a dispersant but by the electrostatic repulsion of the modified functional group. When this pigment is applied to recording paper, dispersion becomes unstable quickly by a change in pH or the evaporation of water, whereby the permeation or bleeding of the ink into the recording paper is suppressed, thereby making it possible to solve the problems of an aqueous ink including the above dispersant. Since an aqueous ink including the above pigment does not need to contain a dispersant such as a polymeric dispersant, it has features that the viscosity of the ink can be reduced and that the ink is dried up quickly, for example.

The above features are advantageously utilized for the aqueous ink for ink jet recording. For example, there is proposed a black ink for aqueous ink jet recording which is prepared by adding a salt to an aqueous ink including a water-insoluble colorant without using a dispersant and carries out dispersion destruction instantaneously on recording paper, to thereby obtain a high concentration and realize high printing quality by suppressing the bleeding of the ink (for example, refer to Japanese Patent Application Laid-Open No. 2000-198955).

However, an ink which does not include a dispersant such as a polymeric dispersant and which includes a water-insoluble colorant to be locally present on the surface of recording paper has a problem that the scratch resistance and marker resistance of a recorded image readily deteriorate because the colorant is present near the surface of the recording paper and a resin is abscent. In order to improve the scratch resistance of an image, it is conceivable that a polymer compound which serves as a binder for a colorant is added to the ink. However, in this case, particularly when a salt is added to the ink in order to improve character quality as described above, the addition of the polymer compound which serves as a binder for a water-insoluble colorant provides a salting out effect due to the salt and greatly reduces storage stability of the ink.

Meanwhile, the chemical modification of a water-insoluble colorant has often been applied to carbon black. This is because a change in color caused by chemical modification rarely causes a problem when the color is black. In contrast to this, when the degree of chemical modification of the surface of an organic pigment such as yellow, magenta, or cyanide was increased in order to improve dispersion stability, the color became dark and a clear full color image was not obtained.

In the case of an aqueous ink including a self-dispersible pigment without using a dispersant, though the formed image has excellent character quality and excellent color developability, it often has a problem in image durability such as scratch resistance and marker resistance. In the case of an aqueous ink including the above self-dispersible pigment and a salt, it is possible to further improve the character quality and color developability of the formed image but image durability such as scratch resistance and marker resistance tends to deteriorate. When excellent image quality which is achieved by a self-dispersible pigment is applied to a color other than black, the color of a color pigment becomes dull, thereby greatly reducing image clearness.

### SUMMARY OF THE INVENTION

It is an object of the present invention to provide an aqueous ink including a self-dispersible colorant, which provides excellent image quality and color developability as well as excellent image durability by improving the scratch resistance and marker resistance of a formed image. It is another object of the present invention to provide an aqueous ink suitable for ink jet recording which solves the above problems of the prior art and can provide a high-quality image having excellent image durability by using an excellent dispersible colorant having sufficiently high dispersion stability, free from the elimination of a resin component from the colorant, stable for a long period of time. It is still another object of the present invention to provide a recorded image which rarely causes “bleeding” in a boundary region between different colors when an aqueous ink including a self-dispersible colorant is used in an ink set having two or more different colors (such a property of such ink will be referred to as “bleeding property” hereinafter).

The inventors of the present invention have conducted intensive studies on means of solving the above problems and have developed a novel dispersible colorant which substantially maintains high dispersion stability without using a surfactant or a polymeric dispersant and has a storage stability for a long period without the elimination or a resin component from the colorant. They have found that an aqueous ink suitable for ink jet recording which has sufficient ejection stability and dispersion stability and provides a printed matter having high image quality and excellent image stability such as scratch resistance and marker resistance for ink jet recording application is obtained by using the above dispersible colorant and a specific salt. That is, the object of the present invention is attained by the following specific means.

That is, according to one aspect of the present invention, an aqueous ink includes a coloring material and water, wherein the coloring material is a dispersible colorant including a colorant and chargeable resin pseudo fine particles smaller in size than the colorant, and the chargeable resin pseudo fine particles are fixed to the colorant; and the aqueous ink further includes at least one kind of salt selected from the group consisting of (M1)₂SO₄, CH₃COO (M1), Ph-COO(M1), (M1)NO₃, (M1)Cl, (M1)Br, (M1)I, (M1)₂SO₃, and (M1) CO₃, wherein M1 represents an alkali metal, ammonia, or organic ammonium and Ph represents a phenyl group.

In addition, according to another aspect of the present invention, an ink set for ink jet recording includes two or more inks, wherein at least one kind of the inks is the above-described aqueous ink.

### BRIEF DESCRIPTION OF THE DRAWINGS

FIGS. 1A and 1B are schematic illustrations showing the basic structure of a dispersible colorant having the chargeable resin pseudo fine particles attached thereto according to the present invention;

FIGS. 2A, 2B, 2C and 2D are schematic illustrations of representative steps of the production method according to the present invention;

FIG. 3 is a schematic illustration of a process for formation of the chargeable resin pseudo fine particles and another step for fixing these particles to a colorant for the production method according to the present invention;

FIG. 4 is a schematically enlarged illustration of chargeable resin pseudo fine particles according to the present invention, viewed from the interface in which they fix to the colorant;

FIG. 5 is a schematically enlarged illustration of the interface in which the chargeable resin pseudo-fine particles of resin fix to the colorant according to the present invention;

FIGS. 6A and 6B are schematic illustrations showing the pigment detachment phenomenon generated when an organic pigment is modified with a hydrophilic group as shown in Japanese Patent Application Laid-Open No. H10-195360; and

FIGS. 7A, 7B and 7C are schematic illustrations showing the agglomerated states of a dispersible colorant on a recording medium.

### DESCRIPTION OF THE PREFERRED EMBODIMENTS

The present invention will be described in detail with reference to the best embodiment of the present invention. The term “dispersible colorant” as used in this specification and claims means a colorant which can be dispersed in water or an aqueous ink medium, that is, has self-dispersibility substantially without adding a surfactant or a polymeric dispersant.

The dispersible colorant used in the ink of the present invention is a dispersible colorant which includes a colorant and chargeable resin pseudo fine particles smaller than the colorant, and the above colorant and the chargeable resin pseudo fine particles fix to each other. Particularly, the chargeable resin pseudo fine particles preferably fix to the colorant such that the particles are sporadically present on the colorant. The dispersible colorant used in the present invention will be described hereinafter.

The ink of the present invention includes the above dispersible colorant and the following salt. That is, the salt used in the present invention is at least one kind of salt selected from (M1)₂SO₄, CH₃COO(M1), Ph-COO(M1), (M1)NO₃, (M1)Cl, (M1)Br, (M1)I, (M1)₂SO₃, and (M1)CO₃, wherein M1 represents an alkali metal, ammonia, or organic ammonium and Ph represents a phenyl group.

Examples of the above alkali metal include Li, Na, K, Rb, and Cs. Examples of the above organic ammonium include methyl ammonium, dimethyl ammonium, trimethyl ammonium, ethyl ammonium, diethyl ammonium, triethyl ammonium, trimethanol ammonium, dimethanol ammonium, ethanol ammonium, and triethanol ammonium. Examples of the salt most preferably used in the present invention include ammonium benzoate, ammonium phthalate, ammonium sulfate, ammonium acetate, ammonium nitrate, ammonium succinate, and ammonium citrate. Those salts are ionized in the ink. For example, ammonium benzoate is ionized into the cation component of ammonium and the anion component of the carboxyl ion of benzoic acid.

When the amount of the salt added to the ink is made large, though the bleeding of the ink is suppressed and color developability becomes high, the dispersion stability and storage stability of the aqueous ink may deteriorate. Therefore, it is preferred to make the amount the largest in a range capable of achiving storage stability required from the viewpoint of product standards. from this point of view, the content of the salt in the aqueous ink is preferably 0.05 to 5 mass %.

A colorant constituting the above-described dispersible colorant is preferably a water-insoluble colorant having a hydrophilic surface. That is, the dispersible colorant used in the present invention is constituted such that chargeable resin fine particles fix to the surface of the colorant. However, the surface of the colorant to which chargeable resin fine particles do not fix is preferably hydrophilic for the following reason. As for a general carbon black colorant, the surface of the pigment is hydrophobic and adsorbs a dispersant such as a polymeric dispersant or a surfactant, thereby stabilizing dispersion. Therefore, when the surfactant or the like is used in the process for producing the dispersible colorant used in the present invention or for the formulation of an ink, it is afraid to hinder the main feature of the ink of the present invention; the colorant is stably dispersed in an aqueous medium by the electrostatic repulsion of the chargeable resin fine particles fixing to the surface of the colorant while dispersion is destroyed instantaneously by the function of a specific salt contained in the ink when the ink is applied to the surface of a recording paper. That is, in this case of using the surfactant or the like, bleeding may occur, or color developability may deteriorate.

The hydrophilic property of the surface of the pigment varies according to the oxidation degree of the surface. According to studies conducted by the inventors, it has been found that character quality and color developability vary according to the oxidation degree of the colorant used. That is, the higher the oxidation degree of the surface of the colorant the lower the adsorption of the dispersant becomes. As a result, the printing properties of the obtained ink improve.

In the case of a general organic pigment, the hydrophilic property of the surface varies according to the polarity of the constituent molecules of the pigment. Particularly the surface of a pigment having oxygen and hydroxyl group in the molecular structure of the pigment has high hydrophilic property. The hydrophilic property of the surface also varies according to the treating method in the finishing step which is carried out at the end of the pigment production process. For example, when the step of drying the pigment is carried out after the solvent is replaced by an aqueous solvent or when the surface of the pigment is finished with an aqueous solvent containing an aqueous resin or the like, the hydrophilic property of the surface of the pigment becomes high.

Since carbon black in particular has a hydrophobic surface and tends to adsorb a dispersant as described above, bleeding is liable to occur. Especially carbon black produced by the furnace method rarely has a hydrophilic group such as a carboxyl group or hydroxyl group on the surface of the pigment and its surface is hydrophobic. To make the surface of such carbon black hydrophilic, it is preferred that carboxyl group or hydroxyl group should be provided by oxidation treatment. Of carbon black, gas black which is produced by Degussa Co., Ltd. under an environment where oxygen is relatively present has a hydrophilic group on the surface and rarely adsorbs a surfactant. Examples of such gas black include FW1, FW2, and FW200 of Degussa Co., Ltd.

The degree of the hydrophilic property (oxidation) of the surface of such carbon black is evaluated as the volatile content (%) of carbon black. In general, when carbon black is heated up to about 1,000° C. in vacuum, gas is generated according to the type of a functional group present on the surface, and the kind and amount of the functional group on the surface can be known by analyzing the total amount or kind of the gas. It can be understood that carbon has a larger amount of the hydrophilic group as the total amount of heating losses increases.

A hydrophilic group such as a carboxyl group or hydroxyl group is rarely present on the surface of the above-described pigment. The volatile content of hydrophobic carbon black obtained by the ordinary furnace method is 2 mass % or less. Carbon put on the market as hydrophilic carbon (for example, BP-L of Cabot Co., Ltd. in U.S.A.) or the like has a volatile content of about 5 mass %. Even when this carbon black is fully treated in dry oxidation, its volatile content is 10 mass % or less.

In contrast to this, as means of further improving the oxidation degree of the surface of carbon black, a wet oxidation method is employed. In this method, carbon black is impregnated with a water phase, an oxidizing agent such as peroxodiacid or peroxodiacid salt is added to carry out a reaction at about 60 to 90° C. for the oxidation of the surface. More specifically, such wet oxidation of carbon black is carried out by the method disclosed by Japanese Patent Application Laid-Open No. 2003-183539. Another wet oxidation method makes use of a hypochloride such as sodium hypochloride or potassium hypochloride for oxidation as disclosed by Japanese Patent Application Laid-Open No. 2003-96372. When carbon having relatively hydrophilic property such as gas black or acidic black is used as carbon to be oxidized, uniform oxidation becomes possible. Further, as described in Japanese Patent No. 3510897, the addition of a carboxyphenyl group or sulfophenyl group directly to carbon using an aromatic diazonium salt can be defined as the wet oxidation reaction of the present invention in a broad sense.

When the adsorption of a polymeric dispersant or surfactant is suppressed by making the surface of a carbon black pigment having a hydrophobic surface hydrophilic, the dispersion stability of the pigment due to the adsorption of the surfactant is deteriorated. As a result, the instantaneous agglomeration of a colorant on a recording paper is carried out smoothly by containing a salt in the ink. Meanwhile, the dispersion stability of the pigment or the durability of an image formed by using the pigment in the ink can be drastically improved by fixing the chargeable resin pseudo fine particles used in the present invention to the pigment as compared with a self-dispersible pigment of the prior art.

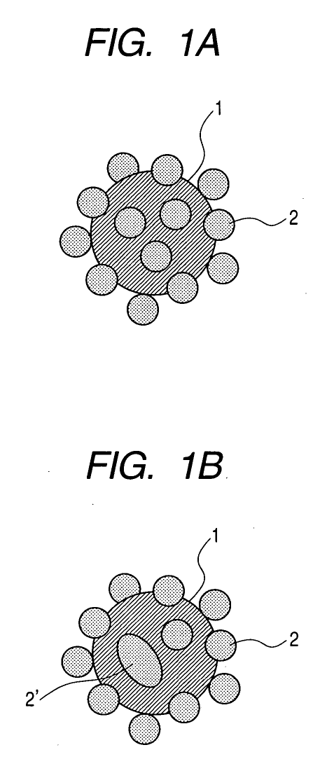

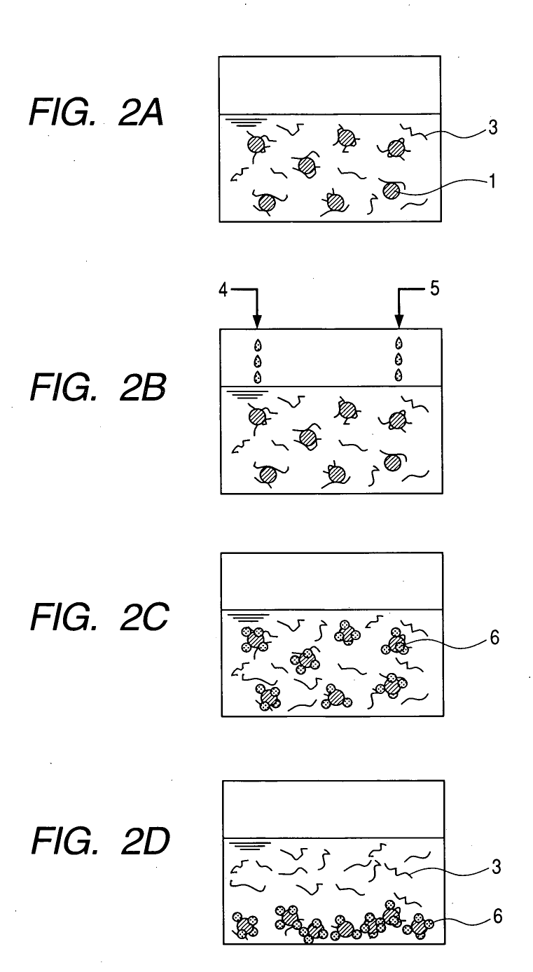

A first feature of the dispersible colorant used in the present invention resides in that the dispersible colorant includes a colorant and chargeable resin pseudo fine particles, wherein the colorant has the particles fixed thereto. FIGS. 1A and 1B schematically illustrate the colorant 1 to which the particles 2 fix the feature or the present invention. FIG. 2B schematically illustrates the chargeable resin pseudo fine particles 2 fix to the colorant 1 surface while being partly fused at the portion 2′.

The colorant is provided with a charge given by the chargeable resin pseudo fine particles fixing to its surface to become dispersible in water or aqueous ink mediums. Thus, the dispersible colorant is produced. At the same time, it exhibits high adhesion to a recording medium due to the presence of the resin component fixing to its surface. Moreover, the dispersible colorant of the present invention exhibits high storage stability for extended periods, because the chargeable resin pseudo fine particles fixing to the colorant surface, not by mere physical adsorption of the resin component, which is the feature of the dispersible colorant of the present invention, are rarely separated from the surface.

The chargeable resin pseudo fine particles for the present invention constitute a resin agglomerate in which the resin components are strongly agglomerated with each other, preferably having many physical crosslinks inside (resin agglomerate is composed of a resin component stably present in the form of fine particles, which may be agglomerated into still fine particles). The chargeable resin pseudo fine particles will be described in detail later.

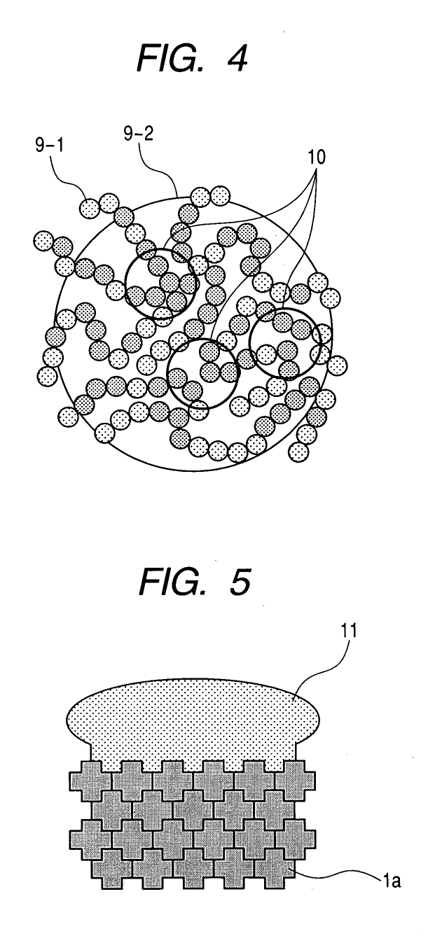

The chargeable resin pseudo fine particles fix to the colorant for the present invention by strong interactions between them. This is considered to be achieved by the following phenomenon. FIG. 4 schematically shows the enlarged interface at which the pseudo-fine, chargeable particles come into contact with the colorant. It should be noted first that the chargeable resin pseudo fine particles 2 are formed by a polymer, composed of various monomer unit compositions (9-1 and 9-2 in FIG. 4), entwined with each other. The polymer locally takes diversified structure in the interface with the colorant, and hence has surface energy widely distributed locally. The colorant and polymer are firmly bound to each other locally where their surface energies, determined by the chemical and surface structure, coincide with each other (dark circles in FIG. 4). There are a plurality of sites at which they coincide with each other in the interface (the sites 10 in FIG. 4). It is considered that the particles fix to the colorant at these sites by strong interactions according to the present invention. In the present invention, a state that a chargeable resin pseudo fine particle as shown in 2′ of FIG. 1B is in contact with a colorant, for example at 30% or more of the surface areas of the particle is referred to as “fusion” for convenience' sake, but this melting is one mode of the fixing, and the chargeable resin pseudo fine particle and the colorant do not always fused to each other at the interface between them.

Each of the chargeable resin pseudo fine particles is composed of polymers strongly interacted with each other to conditionally form physical crosslinks. This prevents the particles from being separated from the colorant or the resin component having a hydrophilic group and from being continuously eluted out of the particle, even when the particle contains many hydrophilic groups. By contrast, a colorant prepared by encapsulation (disclosed by, e.g., Japanese Patent Application Laid-Open No. HOB-183920) may not always exhibit sufficient storage stability for extended periods, because a highly hydrophilic resin cannot be strongly bound to the colorant.

The chargeable resin pseudo fine particles fixing to the colorant for the dispersible colorant of the present invention brings another advantage of increased specific surface area by the morphology of the fixation. The increased specific surface area helps appear the charge on the particles to the colorant surface very efficiently. As a result, the dispersible colorant surface is highly charged. In other words, the dispersible colorant of the present invention has a morphology by which its surface is charged more efficiently and highly, and exhibits higher dispersion stability than the one coated with a resin representatively disclosed by Japanese Patent Application Laid-Open No. H08-183920, even when its resin component has a lower substantial acid or amine value.

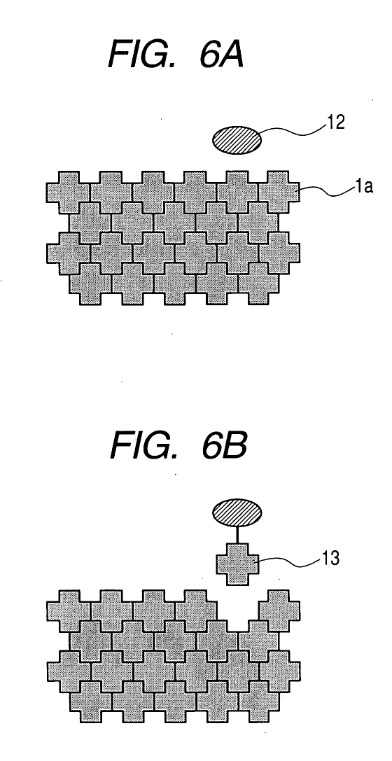

In general, organic pigments are insolubilized (becoming pigments) when their color-developing colorant molecules are crystallized by strong interactions. When an organic pigment is used as the colorant for the dispersible colorant of the present invention, the chargeable resin pseudo fine particles fix to the pigment particle over several colorant molecules therein, as shown in FIG. 5, because there plural interaction sites in the interface between the pseudo-fine, chargeable particle and colorant, as discussed earlier. Therefore, the “pigment detachment” (illustrated in FIGS. 6A and GB) caused by the colorant locally becoming hydrophilic should not occur in the present invention. It is preferable with an organic pigment as the colorant that the chargeable resin pseudo fine particles are kept smaller than the dispersed pigment particles but larger than the colorant molecules, to produce the dispersible colorant comprising the highly dispersible pigment without destroying the pigment crystal structure.

The condition of the chargeable resin pseudo fine particles “fixing” to the colorant in the present invention can be simply confirmed by the following procedure involving separation with three stages. In the first stage, the colorant to be confirmed is separated from other water-soluble components (including water-soluble resin) present in an ink or aqueous dispersion. In the second stage, the colorant and water-insoluble resin component are separated from the precipitate produced in the first stage. In the third stage, the weakly adsorbed resin component and dispersible colorant to which the chargeable resin pseudo fine particles fix are separated, to quantitatively analyze the resin component in the supernatant solution produced in the third stage, and to compare the precipitate produced in the second stage with those produced in the third stage. This procedure can confirm the conditions under which the chargeable resin pseudo fine particles fix to the colorant.

More specifically, the condition can be confirmed by the following procedures. An ink or water dispersion (20 g) is prepared in such a way as to be dispersed with a colorant in around 10% by mass of the total solid content, and centrifugally treated at 12,000 rpm for 60 minutes in the first stage. The resulting precipitate containing the colorant, settled as the lower layer, is redispersed in almost 3 times larger quantity of pure water, and centrifugally treated at 80,000 rpm for 90 minutes in the second stage. Then, the resulting precipitate containing the colorant, settled as the lower layer, is redispersed in 3 times larger quantity of pure water, and centrifugally treated again at 80,000 rpm for 90 minutes in the third stage. The resulting precipitate containing the colorant, settled as the lower layer, is collected from the system. The precipitate produced in the second and third stage is dried under a vacuum at 30° C. for 18 hours and observed by a scanning electron microscope at a magnification of 50,000, where each sample is prepared to contain about 0.5 g of the solids. When the dispersible colorant is observed to have plural fine particles or similar agglomerates fixing to the surface, and the precipitate produced in the second and third stage have the similar morphology, then it is judged that the resin pseudo fine particles fix to the colorant. Moreover, about half of the upper supernatant layer produced in the third stage is slowly collected from the system and dried at 60° C. for 8 hours, to determine the solid content from the weight difference before and after drying. When it is less than 1%, it is judged that no resin pseudo fine particles are separated from dispersible colorant and that these particles fix to the colorant.

The separation condition described above is a preferable example, but any procedure can be employed to judge whether or not the colorant is the dispersible one of the present invention, so long as it satisfies the object of the separation in three stages. More specifically, the first stage is to separate a colorant present in an ink or aqueous dispersion and resin components adsorbed thereon from water-soluble components. The second stage is to separate the colorant and resin component fixing thereto from the other resin component(s) adsorbed on the colorant. The third stage is to confirm that the resin component fixing to the colorant is not separated from the colorant. It is needless to say that any procedure which can satisfy the object of each stage may be used, whether it is known or newly developed. It may involve more than or less than three stages.

A second feature of the dispersible colorant used in the present invention resides in that the dispersible colorant is singly dispersible in an aqueous medium with the chargeable resin pseudo fine particles 2 fixing to the water-insoluble colorant 1. As discussed earlier, the dispersible colorant of the present invention is self-dispersible, i.e., it can be stably dispersed in water and aqueous ink essentially in the absence of surfactants or polymeric dispersants. The definition and judgment procedure will be described later. The dispersible colorant of the present invention can dispense without any polymeric dispersant, another resin component or surfactant, which may be separated from the colorant over long periods and has been traditionally incorporated to stabilize colorant dispersion. As a result, the dispersible colorant of the present invention gives another advantage to aqueous ink, increased freedom of design of components other than the dispersible colorant. Therefore, the aqueous ink incorporated with the dispersible colorant of the present invention can secure sufficiently high printing concentration even on an ink-permeable recording medium, e.g., plain printing paper.

Self-dispersibility of the dispersible colorant of the present invention can be confirmed by, e.g., the following procedure. The ink or aqueous dispersion dispersed with the colorant is diluted 10 times thinly with pure water, and concentrated to the original concentration by an ultrafilter having a cut-off molecular weight of 50,000. The concentrated solution is centrifugally treated at 12,000 rpm for 2 hours, and the resultant precipitate is collected and redispersed in pure water. The colorant is judged to be self-dispersible, when the precipitate is well redispersed. Whether or not they are well redispersed may be judged by taking into consideration the following observations; uniform dispersion is visually observed, no precipitate is notably observed after the solution is allowed to stand for 1 to 2 hours, or precipitate, if any, can be dispersed by lightly shaking the solution, and the dispersed particle diameter, determined by dynamic light scattering, is 2 times or less as large as the original diameter before the treatment.

As described earlier, the dispersible colorant of the present invention has a large specific surface area caused by the chargeable resin pseudo fine particles fixing to the colorant, and realizes excellent storage stability by being massively charged on the vast area. The more preferable results can be produced when the chargeable resin pseudo fine particles massively fix to the colorant while being uniformly distributed. It is particularly preferable that these particles are apart from each other at a certain distance, and preferably distributed uniformly. Still more preferably, the colorant surface is exposed between these particles. These morphologies can be confirmed by a transmission or scanning electron microscope. In other words, the microscopic observation can confirm whether or not these particles are apart from each other at a certain distance, or the colorant surface is exposed between these particles. These particles may be locally closer to each other or fused with each other in some cases. However, it is self-evident for the industry concerned that these particles fix to the colorant, when they are apart from each other at a certain distance or the colorant surface is exposed between these particles as a whole, and these conditions are distributed.

Moreover, the aqueous ink incorporated with the dispersible colorant of the present invention is found to be fast drying on a recording medium, conceivably resulting from the following mechanism, which, however, is not fully substantiated. The dispersible colorant is dispersed in an ink with the chargeable resin pseudo fine particles fixing to the colorant surface, as discussed earlier. When the ink reaches a recording medium, the solvent in the ink is absorbed in fine pores on the medium (voids between cellulose fibers in the case of plain paper, or fine pores in the receiving layer in the case of coated or glossy paper) by the capillary phenomenon. Then, the dispersible colorant of the present invention forms a number of fine interspaces in the area where the colorant comes into contact with each other and chargeable resin pseudo fine particles are uniformly distributed, resulting from its morphological characteristic. Therefore, the ink solvent present between the colorant particles is quickly absorbed in the recording medium by the capillary phenomenon. The aqueous ink of the present invention exhibits more preferable fast-drying characteristics when it is incorporated with dispersible colorant having the chargeable resin pseudo fine particles uniformly distributed on the surface. This observation supports the above mechanism for fast drying.

According to studies conducted by the present inventors, it has been found that by adding a specific salt of the above-described organic ammonium or the like to an ink solvent, the concentration of the salt in the ink solvent jumps together with the permeation of the ink solvent into a recording paper and the evaporation of water, thereby resulting in that the dispersion stability of the pigment is impaired and the agglomeration of the pigment is generated. That is, by adding a specific salt to the ink, the bleeding of an insoluble colorant such as a pigment along the fibers of a recording paper or the permeation of the insoluble colorant into the inside of the recording paper is suppressed, thereby making it possible to form an image which is free from bleeding and has high character quality and high color developability. In particular, agglomeration of a colorant material is very efficiently carried out in the present invention. This reason is assumed as follows. Since a usual resin dispersant or the like extends from a colorant toward a dispersible medium, even if the charge of it disappears by a salt, there is easily generated steric hindrance between the colorant materials. On the contrary, since the chargeable resin pseudo fine particles used in the present invention have a particle-shape, the apparent particle-size of the colorant material is made smaller and therefore there is not easily generated steric hindrance between the colorant materials after the charge of the chargeable resin pseudo fine particles disappears by a salt.

When the surface of a water-insoluble colorant such as a pigment to which chargeable resin fine particles do not fix as described above has high hydrophobic property, a surfactant to be added to the ink solvent or a dispersant such as a water-soluble polymer used to produce the dispersible colorant used in the present invention is adsorbed to the surface of the pigment, whereby the quick drying properties of the dispersible colorant may be hindered. To prevent such a trouble caused by the adsorption of the dispersant, it is effective that a pigment having a highly hydrophilic surface should be selected, the surface of the pigment should be covered with a hydrophilic compound in the finishing step in the process for producing the pigment, or a pigment which is wet or dry oxidized in advance to increase the ratio of oxygen atoms on the surface should be used.

Next, each component for the dispersible colorant of the present invention will be described.

Colorant

The colorant which is one component for the dispersible colorant of the present invention is described. It may be any known or newly developed colorant. However, it is preferably of a hydrophobic dye, inorganic pigment, organic pigment, metallic colloid, or colored resin powder which is insoluble in water and can be stably dispersed in water in the presence of a dispersant. It preferably has a particle diameter of 0.01 to 0.5 μm (10 to 500 nm) when dispersed, more preferably 0.03 to 0.3 μm (30 to 300 nm). The dispersible colorant of the present invention dispersed to have a particle diameter in the above range serves as a preferable dispersible colorant for aqueous inks, because such colorant gives high coloring capacity and high weather resistance of images. The dispersed diameter is the cumulant average determined by dynamic light scattering.

The inorganic pigments useful for the colorant include carbon black, titanium oxide, zinc white, Zinc oxide, Tripon, iron oxide, aluminum oxide, silicon dioxide, Kaolinite, montmorillonite, talc, barium sulfate, calcium carbonate, silica, alumina, cadmium red, iron oxide red, molybdenum red, chrome vermillion, molybdate orange, yellow lead, chromium yellow, cadmium yellow, yellow iron oxide, titanium yellow, chromium oxide, Pyridian, cobalt green, titanium cobalt green, cobalt chromium green, deep blue, ultramarine blue, Prussian blue, cobalt blue, cerulean blue, manganese violet, cobalt violet and mica.

The organic pigments useful for the present invention include those based on azo, azomethine, polyazo, phthalocyanine, quinacridone, anthraquinone, indigo, thioindigo, quinophthalone, benzimidazolone, isoindoline and isoindolinone.

The organic, water-insoluble colorants useful for the present inventin include hydrophobic dyes, e.g., those based on azo, anthraquinone, indigo, phthalocyanine, carbonyl, quinoneimine, methine, quinoline and nitro. Of these, dispersed dyes are particularly preferable.

In this case, as set forth in claims 3, 4 and 5, it is further preferable that a pigment has a hydrophilic surface on which oxygen atoms are exposed. On such a hydrophilic surface, there is not generated absorption of a surfactant or polymeric dispersant which is applied in dispersion production or ink formulation. The pigments are dispersed by only the electrostatic repulsion of the chargeable resin pseudo fine particles to remarkably improve a rapid drying property, thereby causing the bleeding with difficult.

Chargeable Resin Pseudo Fine Particles

The chargeable resin pseudo fine particles which is another component for the dispersible colorant of the present invention are defined as a fine agglomerate of a resin of a sufficiently high polymerization degree, having a small dispersed unit (dispersed diameter) in water (or ink) in which they fix to the colorant. The fine agglomerate is morphologically close to a sphere in a pseudo manner or in the form of agglomerated fine particles (chargeable resin pseudo fine particles) having a uniform size in a certain range. The resin component for the chargeable resin pseudo fine particles are preferably composed of particles physically or chemically crosslinked to each other. Whether or not they are crosslinked to each other can be confirmed by, e.g., the following procedure. The resin component which constitutes the pseudo-fine, chargeable particles is estimated beforehand by a known analytical procedure, and a linear polymer having the same chemical structure (or monomer unit composition) is synthesized by solution polymerization. Then, the chargeable resin pseudo fine particles and the polymer are immersed in an organic solvent as a good solvent for the polymer to compare their solubility. The chargeable resin pseudo fine particles are judged to be crosslinked inside when they have a lower solubility than the polymer.

Another preferred embodiment is those having a cumulant average diameter of not less than 10 nm and not more than 200 nm, when it is measurable by dynamic light scattering. The particles more preferably have a polydisperse index of the dispersed diameter kept at less than 0.2, viewed from storage stability of the dispersible colorant for extended periods. Stabilization of the finely dispersed colorant as the primary object of the present invention may not be achieved when the dispersed particles have an average diameter of more than 200 nm or a polydisperse index more than 0.2. On the other hand, the dispersed chargeable resin pseudo fine particles having an average diameter less than 10 nm may not bring the advantage of the present invention, because they cannot sufficiently keep morphology of chargeable resin pseudo fine particles and the resin is more easily dissolved in water. The dispersed particles having an average diameter of not less than 10 nm and not more than 200 nm can efficiently realize stable dispersion of the colorant brought by the chargeable resin pseudo fine particles fixing to the colorant, because they are smaller than the colorant particles. The above preferred embodiments are valid when the diameter of dispersed chargeable resin pseudo fine particles cannot be measured. In this case, the diameter may be determined by electron microscopic observation. The preferred diameter range is considered to be the same as the above or close thereto.

When the colorant is of an organic pigment, it is particularly preferable that the dispersed chargeable resin pseudo fine particles have an average diameter in the above range, and, at the same time, smaller than that of the dispersed pigment and larger than that of the dispersed colorant molecules, because the structurally very stable and highly dispersible colorant can be obtained when these conditions are satisfied.

The chargeable particles for the present invention are those themselves having some ionized functional group in an aqueous medium, preferably self-dispersible by the chargeability. Whether the resin pseudo fine particles are chargeable or not may be confirmed by one of the following known methods; measurement of the zeta potential on the particle surface, potentiometric titration to determine functional group density, described later, confirmation of dependence of the dispersion stability of the chargeable resin pseudo fine particles on the electrolyte concentration after the aqueous dispersion of the particles is incorporated with an electrolyte, and analysis of the chemical structure of the chargeable resin pseudo fine particles to confirm whether an ionic functional group is present or not.

The resin component for the chargeable resin pseudo fine particles is not limited, and may be selected from any natural or synthetic polymeric compound, and the polymeric compound newly developed for the present invention. Those useful for the resin component for the present invention include acrylic, styrene/acrylic, polyester, polyurethane and polyurea resin, and polysaccharides and polypeptides. In particular, polymers and copolymers having a radically polymerizable unsaturated bond, into which acrylic, styrene/acrylic resins are classified, are preferably used because they can be generally used and easily processed to design functions of the pseudo-fine, chargeable particles.

The monomers having a radically polymerizable unsaturated bond (hereinafter referred to as radically polymerizable monomers or simply monomers) preferably used for the present invention include hydrophobic monomers, such as (meth)acrylic esters, e.g., methyl acrylate, ethyl acrylate, isopropyl acrylate, n-propyl acrylate, n-butyl acrylate, t-butyl acrylate, benzyl acrylate, methyl methacrylate, ethyl methacrylate, isopropyl methacrylate, n-propyl methacrylate, n-butyl methacrylate, iso-butyl methacrylate, t-butyl methacrylate, tridecyl methacrylate and benzyl methacrylate; styrene-based monomers, e.g., styrene, α-methylstyrene, o-methylstyrene, m-methylstyrene, p-methylstyrene and p-tert-butylstyrene; itaconic acid esters, e.g., benzyl itaconate; maleic acid esters, e.g., dimethyl maleate; fumaric acid esters, e.g., dimethyl fumarate; and acrylonitrile, metahcrylonitrile and vinyl acetate.

The following compounds falling into the category of hydrophilic monomers are also preferably used; monomers having an anionic group, such as those having carboxylic group, e.g., acrylic acid, methacrylic acid, crotonic acid, ethacrylic acid, propyl acrylate, isopropyl acrylateitaconic acid, fumaric acid and a salt thereof; those having sulfonic acid group, e.g., styrene sulfonate, 2-propylacrylamide sulfonate, acrylic acid-2-ethyl sulfonate, methacrylic acid-2-ethyl sulfonate, butylacrylamide sulfonate and a salt thereof; and those having phosphonic acid group, e.g., methacrylic acid-2-ethyl phosphonate and acrylic acid-2-ethyl phosphonate. Of these, acrylic acid and methacrylic acid are more preferable.

Synthesis of the Chargeable Resin Pseudo Fine Particles and Their Fixation to a Colorant

The chargeable resin pseudo fine particles can be synthesized by a known procedure or method, and can be fixed to a colorant also by a known method for compositing with a colorant. The inventors of the present invention have invented, after having extensively studied, a method for simply producing the characteristic dispersible colorant comprising a colorant and chargeable resin pseudo fine particles having a smaller size than the colorant, wherein the colorant and particles are fixed to each other. The method of producing the dispersible colorant according to the present invention, which is preferably conducted in the present invention will be described below.

The inventors of the present invention have found that the dispersible colorant having the above characteristics can be very simply produced by aqueous deposition polymerization process carried out under the following conditions. First, a water-insoluble colorant is dispersed in the presence of a dispersant to prepare an aqueous solution dispersed with the colorant. Then, a radically polymerizable monomer is polymerized in the presence of a radical-polymerization initiator in the aqueous dispersion by aqueous deposition polymerization process to fix chargeable resin pseudo fine particles to the colorant. The dispersible colorant prepared by the aqueous deposition polymerization process comprises the chargeable resin pseudo fine particles, which are also prepared by the process and uniformly distributed, fixing to the colorant. The dispersible colorant shows excellent dispersion stability by itself. The chargeable resin pseudo fine particles can be easily controlled to have the preferred characteristics described above by the aqueous deposition polymerization process, while well achieving the characteristic of the present invention of fixing to the colorant. The preferred embodiments of the above production method will be described below in detail.

Dispersion of the Water-Insoluble Colorant

First, the water-insoluble colorant, selected from those cited as the preferable ones for the present invention, is dispersed in the presence of dispersant to prepare an aqueous dispersion. The dispersant for dispersing the colorant in an aqueous solution is not limited, and may be ionic or nonionic. It is however preferable to use a polymeric dispersant or water-soluble polymeric compound to keep dispersion stability in the subsequent polymerization step. The particularly preferable one is a radically polymerizable monomer which is sufficiently soluble in water, and to be incorporated onto the fine colorant particle surface and in the polymerization step. Still more preferably, it has a hydrophobic segment which provides adsorption sites for a hydrophobic monomer at the oil droplet interface. Still more preferably, it has at least one type of the hydrophobic monomer used in the subsequent polymerization step as the constituent unit, because it can accelerate fixation of the chargeable resin pseudo fine particles to the colorant in that step.

The method for producing a polymeric dispersant or water-soluble polymeric compound serving as the dispersant for the present invention is not limited. For example, it can be produced by reacting a monomer having an ionic group with another polymerizable monomer in a non-reactive solvent in the presence or absence of a catalyst. It is found that good results can be produced by a dispersant of a styrene/acryl-based polymeric compound produced by polymerization of the above-described monomer having an ionic group and styrene monomer as the essential components, or acryl-based polymeric compound having an ionic group produced by polymerization of the monomer having an ionic group and (meth)acrylic acid ester-based monomer of not less than 5 carbon atoms as the essential components. It is preferable to use an anionic dispersant when the dispersible colorant having an anionic group is to be produced, and a dispersant having a cationic group or nonionic dispersant when the dispersible colorant having a cationic group is to be produced.

When fixation of the chargeable resin pseudo fine particles to the colorant is to be accelerated in the aqueous deposition polymerization process and, at the same time, dispersion stability of the colorant is to be kept in the polymerization step, it is a preferred embodiment to use an anionic dispersant having an acid value of not less than 100 and not more than 250, or a cationic dispersant having an amine value of not less than 150 and not more than 300. In the presence of a dispersant having an acid or amine value below the above range, the chargeable resin pseudo fine particles may not be kept well dispersed, because the hydrophobic monomer is more compatible with the dispersant than with the colorant in the subsequent aqueous deposition polymerization process, as a result of which the dispersant is separated from the colorant surface before the chargeable resin pseudo fine particles fix to the colorant. In the presence of a dispersant having an acid or amine value beyond the above range, on the other hand, fixation of the chargeable resin pseudo fine particles to the colorant surface may be retarded, because it is excessively strong in volume-displacing effect or static repulsion on the colorant surface. When an anionic dispersant is to be used, it preferably has carboxyl group as the anionic group, viewed from not retarding fixation of the chargeable resin pseudo fine particles to the colorant.

In the step for dispersing a water-insoluble colorant to prepare the aqueous dispersion, the colorant preferably has a diameter of not less than 0.01 μm and not more than 0.5 μm (not less than 10 nm and not more than 500 nm), particularly preferably not less than 0.03 μm and not more than 0.3 μm (not less than 30 nm and not more than 300 nm), after being dispersed. The dispersed diameter in this step is greatly reflected in the dispersed diameter of the dispersible colorant produced. Therefore, it is preferably in the above range, viewed from coloring capacity of the colorant, weather resistance of the image, and its dispersion stability.

The water-insoluble colorant for the present invention preferably has a dispersed particle size close to the monodisperse distribution. In general, the dispersible colorant with the chargeable resin pseudo fine particles fixing to the colorant generally tends to have a particle diameter distribution narrower than that in the aqueous dispersion to be treated in the polymerization step shown in FIG. 2B, although basically depending on the latter distribution. It is important to narrow the colorant particle diameter distribution, viewed from securely inducing fixation of the chargeable resin pseudo fine particles to the colorant by hetero-agglomeration. The inventors of the present invention have found that use of the colorant having a polydisperse index of 0.25 or less gives the dispersible colorant of excellent dispersion stability.

Different analytical procedures give a varying particle diameter of a dispersed colorant. In particular, organic pigment particles are rarely spherical. In this specification, the particle diameter is represented by the average particle size and polydisperse index, measured by dynamic light scattering (analyzer: Otsuka Electronics ELS-8000) and determined by the cumulant analysis.

The method of dispersing a water-insoluble colorant in water is not limited, so long as it is selected from those capable of stably dispersing a colorant in water under the conditions described earlier in the presence of the dispersant also described earlier. It may be known or newly developed for the present invention. When a water-insoluble colorant is a pigment, a polymeric dispersant is incorporated generally suitably at not less than 10% and not more than 130% by mass based on the pigment.

The colorant dispersing method for the present invention is not limited, so long as it is commonly used for the colorant, and may be selected from those using a dispersing machine, e.g., paint shaker, sand mill, agitator mill, three-roll mill or the like, high-pressure homogenizer, e.g., microfluidizer, nanomizer or multimizer, or ultrasonic dispersing machine.

Aqueous Deposition Polymerization Process

Next, the preferred embodiments will be described for the aqueous deposition polymerization process as a step for synthesizing the chargeable resin pseudo fine particles and fixing them to the colorant, which is the feature of the present invention. It should be understood that the present invention is not limited by the embodiments described below. FIGS. 2A to 2D schematically illustrate the process flow of this process. The process is considered to comprise the following steps for producing the dispersible colorant. First, a colorant 1 is dispersed in an aqueous solution in the presence of a dispersant 3 to prepare the aqueous dispersion (FIG. 2A). Dispersion of the colorant 1 is stabilized in the presence of the adsorbed dispersant 3, the adsorption being thermally in equilibrium. Next, the aqueous dispersion prepared above is heated with stirring, to which a monomer component 4 is added together with, e.g., an aqueous radical-polymerization initiator 5 (FIG. 2B). The initiator 5 is decomposed under heating to release the radicals thereby accelerating the reactions between the hydrophobic monomer dissolved in trace quantities in the aqueous phase and the water-soluble monomer present in the aqueous phase.

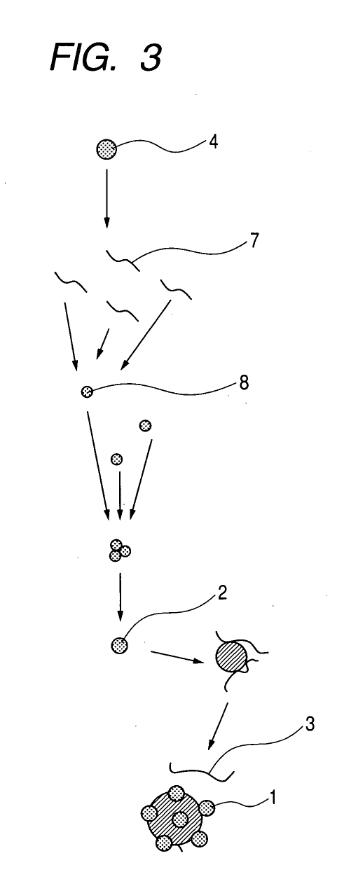

FIG. 3 schematically illustrates a step from polymerization of the monomer 4 to production of a dispersible colorant 6 (FIG. 2C). As the monomer 4 reaction described above proceeds, a oligomer 7 formed by polymerization of the monomer component becomes insoluble in water and becomes a precipitate 8 after separating out of the aqueous phase. The separated oligomer particles are not sufficient in dispersion stability, and are combined with each other to form the chargeable resin pseudo fine particles 2. These fine particles 2 undergo hetero-agglomeration with the hydrophobic surfaces of the colorant in the aqueous dispersion as nuclei, and the resin component which constitutes the pseudo-fine, chargeable particles 2 is strongly adsorbed on the surface of the colorant 1 by the hydrophobic interactions, while the polymerization reaction is proceeding within the chargeable resin pseudo fine particles 2. As a result, these fine particles 2 are transformed into a more energy-stable morphology while increasing the adsorption sites. At the same time, physical crosslinks are formed to a high extent within the chargeable resin pseudo fine particles 2, with the result that the fine particles 2 are solidified after reaching the morphology in which they are adsorbed most stably. The colorant 1, on the other hand, is stabilized, as the chargeable resin pseudo fine particles 2 are fixed thereto, allowing the dispersant adsorbed thereon to separate from the surface.

FIG. 4 schematically illustrates both sides of the interface between the chargeable resin pseudo fine particles 2 formed above and colorant 1. As shown, the chargeable resin pseudo fine particles 2 which are the agglomerates of the resin component have a hydrophilic monomer units 9-1 and hydrophobic monomer units 9-2. They are arbitrarily distributing to cause a distribution of local surface energy, and there are a number of adsorption sites 10 at which their surface energy coincides with that of the colorant.

FIG. 5 schematically illustrates the enlarged interface in which part of the pseudo-fine, chargeable particle of resin 11 fixes to part of the colorant particle 1a. The pseudo-fine, chargeable particle of resin 11 adsorbs the adsorption site 10 shown in FIG. 4 at the interface to fix to the colorant stably in a morphology which depends on the surface shape of the colorant part 1a. As described earlier, the polymerization proceeds within the pseudo-fine, chargeable particle of resin also during this step, and the particle is fixed to the colorant after reaching the morphology in which they are adsorbed most stably. The dispersible colorant of the composition described above can be easily produced by these steps (FIG. 2D). In the system with the chargeable resin pseudo fine particles sufficiently charged on the surface to be self-dispersible, they are apart from each other by the static repulsive force while they are adsorbed on and fix to the colorant by hetero-agglomeration to be uniformly distributed on the colorant particle surfaces. As a result, they take the preferred morphology described earlier.

The polymerization conditions vary depending on characteristics of the polymerization initiator, dispersant and monomer. Examples of the conditions are reaction temperature: not more than 100° C., preferably not less than 40° C. and not more than 80° C., reaction time: 1 hour or more, preferably not less than 6 hours and not more than 30 hours, and stirring rate: not less than 50 rpm and not more than 500 rpm, preferably not less than 150 rpm and not more than 400 rpm.

In the above process, in particular when the chargeable resin pseudo fine particles are to be produced by polymerization of a monomer component containing at least one type of hydrophobic monomer and at least one type of hydrophilic monomer, the monomer component is preferably dropped in an aqueous dispersion of a water-insoluble colorant, incorporated beforehand with an aqueous radical-polymerization initiator. Or otherwise, the monomer component and aqueous radical-polymerization initiator are dropped in an aqueous dispersion of water-insoluble colorant simultaneously or separately, which is still a preferred embodiment. When a monomers mixture is composed of dissimilar monomers, e.g., hydrophobic monomers and hydrophilic monomers, it is preferable to keep the copolymerization ratio of the monomers at a constant to uniformly produce the desired chargeable resin pseudo fine particles. When the monomer mixture is incorporated in the polymerization system in excess of the quantity consumed by the polymerization reaction in a certain time, a specific monomer may be preferentially polymerized leaving the other, which is polymerized after the former monomer is consumed. In this case, the resulting chargeable resin pseudo fine particles may have significantly uneven characteristics. Some of these particles, in particular those containing the hydrophilic monomer component at a high proportion, may not fix to the colorant surface.

Moreover, the resin component containing the hydrophilic monomer component at a high proportion may not even separate out due to its high hydrophilicity to remain as a water-soluble resin component in the system without forming the chargeable resin pseudo fine particles. On the other hand, the hydrophobic/hydrophilic monomer copolymerization ratio can be kept at a constant to uniformly form the chargeable resin pseudo fine particles of a desired copolymerization ratio, when the monomer component is dropped in an aqueous dispersion of water-insoluble colorant containing an aqueous radical-polymerization initiator.

Some hydrophilic monomers, in particular anionic ones, e.g., acrylic acid and methacrylic acid, may become partly unstable to agglomerate, depending on characteristic of a polymeric dispersant working to disperse a colorant. It is a preferred embodiment of the present invention to incorporate an anionic monomer in the form of a sodium or potassium salt after it is neutralized, in order to avoid the above problem.

The above process for forming the chargeable resin pseudo fine particles fixing to the water-insoluble colorant is preferably followed by a purification treatment step to produce the aqueous ink containing the colorant. It is important for producing the dispersible colorant of high storage stability for extended periods to purify the mixture containing unreacted polymerization initiator, monomer component or dispersant, or water-soluble resin component or chargeable resin pseudo fine particles which fail to fix to the colorant. The purification step may be selected from those commonly used. Purification by centrifugal separation or ultrafiltration is a preferred embodiment.

The dispersible colorant with the chargeable resin pseudo fine particles containing a desired copolymer fixing to the colorant surface can be produced by employing the above steps, because many control parameters are well controlled. When an anionic monomer is incorporated to realize high dispersion stability, in particular the steps for the present invention can secure a high surface functional group density and thereby high dispersion stability for the dispersible colorant, even when the anionic monomer is used in a relatively small quantity. Therefore, these steps can enhance dispersion stability of the chargeable resin pseudo fine particles without deteriorating storage stability of the dispersible colorant for extended periods.

The inventors of the present invention assume that the improved dispersion stability of the dispersible colorant results from the following mechanisms, which, however, are not fully substantiated. While the chargeable resin pseudo fine particles are being formed from the oligomers separating out during the polymerization step, initiated by the radicals generated in water, the oligomers containing the component derived from the anionic monomer at a higher content are preferentially oriented to the aqueous phase side, i.e., to the vicinity of the chargeable resin pseudo fine particles. This condition is kept after the chargeable resin pseudo fine particles fix to the colorant to further concentrate the anionic group derived from the anionic monomer component on the surface of the dispersible colorant of the present invention having structurally a large specific surface area. As a result, the dispersible colorant produced by the method of the present invention can be stabilized by a smaller quantity of the anionic monomer component.

Aqueous Ink

The aqueous ink of the present invention is characterized by containing the dispersible colorant described above. When a pigment is used for the colorant, it is incorporated normally at not less than 0.1% and not more than 20% by weight based on the ink, preferably not less than 0.3% and not more than 15% by weight. It is preferable for the aqueous medium for the ink to contain water or water-soluble organic solvent, as required. The ink may be incorporated with a penetrant to accelerate its penetration into a recording medium, a preservative or an antifungal agent.

The dispersible colorant of the present invention contains the chargeable resin pseudo fine particles 2 fixing to the colorant 1 surface (FIGS. 1A and 1B) while it is present in the ink. Therefore, the colorant particle attaches to a recording medium or to an adjacent particle on the medium via the chargeable resin pseudo fine particles fixing to its surface. Therefore, the image produced with the aqueous ink of the present invention should be highly resistant to scratching. One of the more preferred embodiments is the aqueous ink which has, in addition to the above characteristics, the self-dispersible fine resin particles present therein. This permits the ink to produce highly glossy images on a glossy medium, which is normally difficult with a common water-insoluble colorant, e.g., pigment. More preferably, the ink has the chargeable resin pseudo fine particles (A) fixing to the colorant and self-dispersible fine resin particles (B) present in the ink, wherein the monomer component of the particles (A) and the monomer component of the particles (B) have at least one type of common monomer component. Such ink composition will greatly improve scratching resistance of the image on a glossy recording medium, because the particles (A) fixing to the colorant and particles (B) are more compatible with each other to increase ink adhesiveness.

When a pigment is used as the colorant, it is a preferred embodiment to incorporate the pigment in a specific ratio to the resin component of the chargeable resin pseudo fine particles, or resin/pigment ratio (B/P ratio) of not less than 0.3 and not more than 4.0 by mass for improved scratching resistance of the image formed by the aqueous ink. Keeping the B/P ratio at not less than 0.3 can enhance adhesiveness between the colorant particles and between colorant particles and recording medium, and hence enhance resistance of the image to scratching. In particular, the aqueous ink incorporated with the dispersible colorant can exhibit its film-making capacity more efficiently, when the copolymer component for the chargeable resin pseudo fine particles fixing to the colorant has a glass transition temperature of not less than −40° C. and not more than 60° C., as described earlier, and further enhance scratching resistance of the image on a glossy paper. At a B/R ratio significantly exceeding 4.0, the ink may be sufficiently viscous as a whole to have deteriorated ejectability, in particular for ink jet recorders. Moreover, such an ink may not secure sufficient image density, because of the excessively high resin ratio to deteriorate color-developing capacity of the colorant on a recording medium. Keeping the B/P ratio in the above range of not less than 0.3 and not more than 4.0 can give the aqueous ink which simultaneously exhibits excellent scratching resistance and ejectability in ink jet recorders.

The resin mass described above means the total quantity of the chargeable resin pseudo fine particles, and may include another resin component which is clearly observed to be strongly adsorbed on the pigment surface. However, it does not include a water-soluble resin component which is easily separated from the pigment.

The B/P ratio can be generally determined by differential thermogravimetric analysis, and was determined by an analyzer (METTLER, TGA/SDTA851) for the present invention. More specifically, the dispersible colorant of the present invention or aqueous ink incorporated therewith for ink jet recording was centrifugally treated at 80,000 rpm for 2 hours, dried, weighed and heated in a nitrogen atmosphere or air to observe weight change of each of the pigment and resin components before and after its decomposition temperature, from which the B/P ratio was determined.

Recorded Image

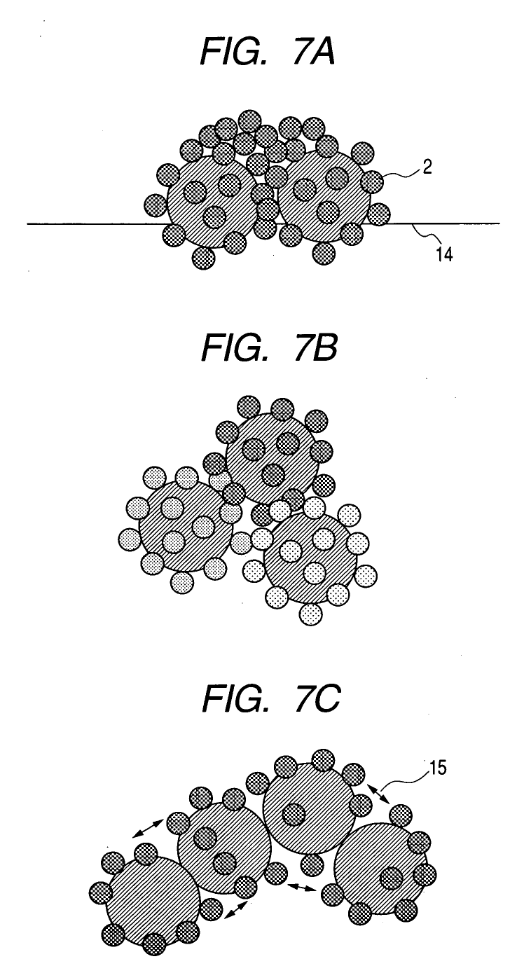

The image of the present invention recorded on a recording medium with the aqueous ink of the present invention incorporated with the dispersible colorant of the above-described composition is produced by the ink jet recorder, described later. The recording medium used for the present invention is not limited, so long as it allows production of an image thereon by ink jet recording. The dispersible colorant of the present invention includes functions by its characteristic shapes, shown in FIGS. 7A, 7B and 7C, for producing the inkjet recorded image of the present invention. Of these functions, those shown in FIGS. 7B and 7C are more preferable, and appear simultaneously in the actual recording. The function shown in FIG. 7A tends to appear where the aqueous ink described above is further incorporated with the self-dispersible resin fine particles B, to produce the highly glossy image on a recording medium 14, where the chargeable resin pseudo fine particles or self-dispersible fine resin particles B accumulate on the medium to smoothen irregularities between the colorant particles. In FIG. 7B, the chargeable resin pseudo fine particles 2 present between the adjacent colorant particles fix simultaneously to these colorant particles, to form a strong colored film for the recorded image of high scratching resistance. FIG. 7C shows another preferred function, where the ratio of the colorant surface to which the chargeable resin pseudo fine particles fix is decreased to partly allow agglomeration of the colorant particles themselves while realizing the function shown in FIG. 7B. FIG. 7C illustrates agglomeration of the colorant particles in the ink by which an image is formed on a recording medium, where static repulsion between the chargeable resin pseudo fine particles (represented by arrows 15 in the figure) is balanced with agglomeration force of the colorant particles in the agglomeration process to control the agglomeration. Such control enables controlling of image density and ink bleeding through colorant agglomeration control on recording medium.

Image Recording Method and Recorder

The dispersible colorant and aqueous ink incorporated therewith, both of the present invention, exhibit excellent characteristics when used in an ink-jet head and stored in an ink tank. The ink is also useful for filling ink. The present invention exhibits particularly excellent characteristics when used in a recording head and recorder of the Bubble Jet type recording method.

The representative structure and working principle are preferably based on the basic principle disclosed in U.S. Pat. Nos. 4,723,129 and 4,740,796. This principle is applicable to an on-demand or continuous type. It is particularly effective when applied to an on-demand type, where at least one driving signal is transmitted to an electrothermal converter placed in a position corresponding to each of a sheet and liquid passage by which the ink is held to rapidly heat the ink to a temperature beyond the nucleate boiling temperature, the converter being sufficiently generating heat to cause film boiling on the heated recording head surface, with the result that the bubbles are formed in the ink corresponding to the signal. The ink is ejected through a ejection port by the actions of the bubbles growing and contracting to form at least one droplet. The pulsed signal is more preferable, because it can immediately and adequately cause growth and contract of the bubbles to achieve ink eject of high response. U.S. Pat. Nos. 4,463,359 and 4,345,262 disclose the preferable pulsed signals. The recording can be performed more effectively under the conditions disclosed by U.S. Pat. No. 4,313,124 describes the temperature rising rate on the heat-working surface in the head.

The preferable head structures include combinations of ejection ports, liquid passages (linear or right angle to liquid passages) and electrothermal converters, as disclosed by the above USP specifications. The present invention is also effective in a structure with the components positioned on the curved heat-working surface, as disclosed by U.S. Pat. No. 4,558,333 or 4,459,600. It is also effective in another structure with plural 2 electrothermal converters sharing one or more common ink ejection ports and their own ejection ports, as disclosed by Japanese Patent Application Laid-Open No. S59-123670. A full-line type recording head, which covers a length corresponding to the maximum width over which the recorder can produce images, may have a combination of a plurality of recording heads disclosed by the above specifications to cover the required length, or may be of such a structure that they are assembled in one body. The present invention helps these types exhibit the above-described effect more efficiently.

The present invention is also effective when fixed to an exchangeable chip type recording head body in which it can be electrically connected to the body to supply ink thereform, and also to a cartridge type in which it is integrally mounted on the recording head itself. The present invention can exhibit its effect more efficiently, when provided, as one component to the recording head, with a recovery unit or another auxiliary means, which is still another advantage of the present invention. More specifically, these include capping, cleaning and pressurizing or inducing means, electrothermal converter or another heating device, preliminary heating means comprising a combination of these devices, and a combination of these devices for a preliminary eject mode which is not for recording.

### EXAMPLES

The present invention will be described in more detail by EXAMPLES and COMPARATIVE EXAMPLES, which by no means limit the present invention, and variations may be made so long as within the scope of the present invention. In EXAMPLES and COMPARATIVE EXAMPLES, “part(s)” and “%” are by mass unless otherwise stated.

### Example 1

A recording ink 1 was prepared by the following procedure in EXAMPLE 1. First, a mixed solution having a composition of 10 parts of carbon black, 6 parts of glycerin, 10 parts of a styrene/acrylic resin-based dispersant and 74 parts of water was prepared as a pigment dispersion solution 1 by treating these components by a sand mill (Kaneda Scientific) with 0.6 mm-diameter zirconia beads at 1,500 rpm for 5 hours to disperse the pigment, where the pot was filled with a filling rate of 70%. The carbon black was Black Pearls 880 (hereinafter referred to as BP880) supplied from US's Cabot Co. The styrene/acrylic resin-based dispersant had a copolymerization ratio of 70/30, molecular weight (Mw) of 8,000 and acid value of 170. It was an aqueous solution prepared by stirring the dispersant together with water and potassium hydroxide in an amount equivalent to the acid value at 80° C. The resulting pigment dispersion solution 1 was stably dispersed with the pigment particles, having an average dispersed particle diameter of 98 nm and polydisperse index of 0.16.

Next, the following three solutions was slowly dropped in 500 parts of the pigment dispersion solution 1 with electrically stirring at 70° C. in a nitrogen atmosphere for polymerization continued for 5 hours. The first solution comprised 28.5 parts of methyl methacrylate monomer. The second solution comprised 1.5 parts of acrylic acid, 0.36 parts of potassium hydroxide and 30 parts of water. The third solution comprised 0.05 parts of potassium persulfate and 30 parts of water. The resulting dispersion solution was diluted by 10 times with water, and centrifugally treated at 5,000 rpm for 10 minutes to remove the agglomerates. It was further centrifugally purified at 12,500 rpm for 2 hours to produce the precipitate as the dispersible colorant 1.

The dispersible colorant 1 dispersed in water and centrifugally purified at 12,000 rpm for 60 minutes. The resulting precipitate was redispersed in water and dried to be analyzed by a scanning electron microscope (JOEL Hightech, JSM-6700) at a magnification of 50,000. It was observed that the dispersible colorant 1 comprised fine resin particles being smaller in size than the carbon black and fixing to the carbon black surface. The colorants prepared in other EXAMPLES were observed in the same manner to confirm the colorant morphologies.

The following composition was incorporated with the dispersible colorant 1, and filtered by a membrane filter (pore size: 2.5 μm) under pressure to prepare the recording ink 1 containing the colorant 1 at 4%.

| | |
|---|---|
| Glycerin | 7 parts |
| Diethylene glycol | 5 parts |
| Trimethylol propane | 7 parts |
| Acetylenol EH (Trade name: Kawaken Fine Chemicals) | 0.2 parts |
| Ammonium benzoate | 0.5 parts |
| Ion-exchanged water | Balance |

### Comparative Example 1

An ink for comparison was prepared in accordance with the same method and formulation as in Example 1 except that ammonium benzoate was not added in Comparative Example 1.

Evaluation

A printing test was carried out as follows by using inks obtained in Example 1 and Comparative Example 1 and the S-700 ink jet printer (manufactured by Canon Inc.). Each of the inks was injected into the empty ink tank for BCI-3EeBK mounted to the S-700 without change to carry out the printing test. As a result, the ink of Example 1 containing ammonium benzoate was much superior to the ink of Comparative Example 1 which did not contain ammonium benzoate in character quality and the bleeding of color in the boundary area between color inks.

### Example 2

In Example 2, inks were prepared in accordance with the same method as in Example 1 except that the amount of ammonium benzoate was changed from 0.01 mass % to 10.0 mass % to evaluate the bleeding and character quality of each of the inks in the same manner as described above. The results are shown in Table 1. As a result, the inks containing the amount of ammonium benzoate smaller than 0.05% were slightly inferior to that of Example 1 in the improvement of character quality and the effect of reducing bleeding (indicated as “Δ” in the table). The inks containing the amount of ammonium benzoate larger than 5 wt % were inferior to that of Example 1 in ejection property with the result that a white streak was apt to occur or a gelled product was apt to be formed in a 3-day storage test at 60° C. It was thus confirmed that other problems may occur by adding ammonium benzoate to the inks.

TABLE 1
Addition of salt and evaluation results

| | Amount | | | | | | | | | | |
|---|---|---|---|---|---|---|---|---|---|---|---|
| | 0.01 | 0.04 | 0.05 | 0.1 | 0.5 | 1.0 | 2.5 | 5.0 | 6.0 | 7.5 | 10.0 |
| Evaluation | Δ | Δ | ∘ | ∘ | ∘ | ∘ | ∘ | ∘ | Δ | Δ | Δ |
| results | | | | | | | | | | | |

The amount is parts by mass.
o: excellent
Δ: may be inferior in some aspects

### Example 3

A dispersible colorant for use in ink was prepared in the same manner as in Example 1 except that carbon black was changed from BP880 used in Example 1 to NIPEX180 (Degussa Co., Ltd. in Germany) To compare the surface state of carbon black in use, the amount of oxygen on the surface of carbon black was measured by the following method. The amount of oxygen on the surface of carbon black was measured by the following heating loss method. In this method, carbon black was heated at 950° C. in vacuum for 10 minutes to estimate the amount of oxygen on the surface from a weight reduction caused by heating. That is, gases generated by heating under the above conditions are carbon monoxide and carbon dioxide which are generated as derived from a carboxyl group, hydroxyl group, quinone, or the like present on the surface of carbon. Therefore, it can be said that the amount of oxygen on the surface becomes larger as a heating loss caused by heating increases. As a result of measurement, the heating loss of BP880 used in Example 1 was 1.5 mass % whereas the heating loss of NIPEX180 used in Example 3 was 5 mass %. It was thus confirmed that the amount of oxygen on the surface of carbon black was larger than that of Example 1.

An ink was prepared by using the above prepared dispersible colorant in accordance with the same method and the same formulation as in Example 1. A printing test was carried out on the obtained ink in the same manner as in Example 1 to evaluate printed properties. As a result, it was confirmed that the ink of this example was superior to that of Example 1 in character quality and bleeding properties.

### Example 4

A dispersible colorant was prepared in the same manner as in Example 1 except that carbon black was changed from BP880 used in Example 1 to the wet oxidized carbon (Tokai Carbon Co., Ltd.). The wet oxidized carbon used in Example 4 was obtained by oxidizing the surface of carbon black in a water phase with an oxidizing agent. When the amount of oxygen on the surface of the wet oxidized carbon was measured in the same manner as in Example 3, it was confirmed that the heating loss of the carbon was 15 mass % and the amount of oxygen on the surface of the carbon used in Example 4 was much larger than those of Examples 1 and 2.

An ink was prepared by using the above prepared dispersible colorant in accordance with the same ink formulation as in Example 3. When printing was carried out in the same manner as in Example 1, the ink of Example 4 was much superior to those of Examples 1 to 3 in character quality and bleeding property.

### Example 5

A dispersible colorant was prepared in the same manner as in Example 1 except that CABOJET-200 (CABOT Co., Ltd. in U.S.A.) was used as a carbon black raw material. This carbon black has a carbonyl group on the surface of carbon. Although it can be said that the producing method is one of the wet oxidizing methods, as the reaction is not a simple oxidation reaction using an oxidizing agent, the cost of the production rises.

An ink (the amount of ammonium benzoate was 1 mass %) was prepared in the same manner as in Example 1 to carry out printing in the same manner as in Example 1 therewith. Extremely excellent printing could be realized. A recorded product by the ink of Example 5 having as high printing quality as using an ink prepared by dispersing CABOJET-200 with a dispersant (to be referred to as “CABOJET-200 ink” hereinafter) could be obtained.

A scratch test by rubbing with fingers and a marker resistance test by using a marker pen were carried out on characters drawn with the ink obtained in Example 5 and characters printed with the CABOJET-200 ink. OPTEX (Zebra Co., Ltd.) was used as the marker pen. As a result, characters printed with the CABOJET-200 ink were blurred in the scratch resistance test and the marker pen was stained with the ink in the marker resistance test. These problems did not occur in the case of the ink of Example 5.

### Example 6

A dispersible colorant was prepared in the same manner as in Example 1 except that the BLACK PEARLS L (CABOT Co., Ltd. in U.S.A.) was used as carbon black. This carbon black was a product obtained by dry-oxidized carbon black in accordance with the furnace method. When the amount of oxygen on the surface of this dry-oxidized carbon black was measured in the same manner as in Example 3, its heating loss was 5 mass %.

When an ink was prepared in accordance with the same method and formulation as in Example 1 to carry out printing therewith, excellent character quality and bleeding property were realized. However, the ink of Example 6 was inferior to the inks of Examples 4 and 5 containing a dispersible colorant prepared from wet-oxidized carbon, in character quality and bleeding property. For the oxidation of the surface of carbon black, dry oxidation is advantageous because it is more inexpensive than wet oxidation which has been described hereinabove but the oxidation degree of the surface is not sufficiently high as compared with wet oxidation and the heating loss is low. Therefore, it was confirmed that the ink prepared from dry-oxidized carbon black was inferior to the ink prepared from wet-oxidized carbon black in character quality and bleeding property.

### Example 7

A dispersible colorant was prepared in the same manner as in Example 1 except that the PY-180 yellow pigment (TONER YELLOW HG) (Clariant Co., Ltd.) was used in place of carbon black. The pigment was a yellow pigment having the structure of benzimidazolone and has extremely high hydrophilic property.

An ink was prepared by using the above dispersible colorant in the same manner as in Example 1. A printing test was carried out in the same manner as in Example 1. In the printing test, the above obtained yellow ink was injected into the S-700 yellow ink tank. At the same time, the black ink prepared in Example 4 was injected into the S-700 black ink tank to carry out a printing test. The black and yellow inks showed excellent color developability. When the boundary between black and yellow colors was observed, it could be confirmed that the bleeding of a mixed color rarely occurred and excellent bleeding property could be obtained by combining these inks.

As described above, according to the present invention, there is provided an aqueous ink capable of providing: high-quality characters which rarely cause the bleeding of ink; an image having excellent image characteristics and high color developability; and further an image having excellent image durability such as scratch resistance and marker resistance. According to the present invention, there is also provided an ink set capable of realizing the recording of an image which rarely causes bleeding between colors and has high color developability by using the above excellent ink as any one of the inks of an ink set having two or more different color inks. The above effects can be attained by using a dispersible colorant having chargeable resin pseudo fine particles smaller in size than a water-insoluble colorant and fixing to the surface of the water-insoluble colorant. That is, since a resin component is present on the surface of the dispersible colorant and is rarely eliminated from the dispersible colorant, the water-insoluble colorant can be dispersed and stabilized sufficiently with a high density of the functional groups of the resin. Further, the image formed with the ink becomes an image having excellent durability such as scratch resistance and marker resistance by the resin constituting the fine particles. Since the ink of the present invention contains a specific salt in addition to the above dispersible colorant, dispersion destruction is carried out instantaneously on a recording paper by the salt to suppress the permeation and bleeding of the ink into the recording paper, whereby the recording of an image which rarely causes bleeding between colors and has high color developability can be realized.

This application claims priority from Japanese Patent Application No. 2004-188900 filed on Jun. 25, 2004, which is hereby incorporated by reference herein.

What is claimed is:

1. An aqueous ink comprising:
a coloring material, wherein the coloring material is a dispersible colorant comprising a colorant and chargeable resin pseudo fine particles smaller in size than the colorant, and the chargeable resin pseudo fine particles are fixed to the colorant;
water; and
at least one kind of salt selected from the group consisting of (M1)₂SO₄, CH₃COO(M1), Ph-COO(M1), (M1)NO₃, (M1)Cl, (M1)Br, (M1)I, (M1)₂SO₃, and (M1)CO₃, wherein M1 represents an alkali metal, ammonia, or organic ammonium and Ph represents a phenyl group.

2. An aqueous ink according to claim 1, wherein a content of the salt in the ink is 0.05 to 5 mass %.

3. An aqueous ink according to claim 1, wherein the colorant constituting the dispersible colorant is a surface-oxidize colorant.

4. An aqueous ink according to claim 3, wherein the colorant constituting the dispersible colorant is wet-oxidized carbon black.

5. An aqueous ink according to claim 3, wherein the colorant constituting the dispersible colorant is dry-oxidized carbon black.

6. An aqueous ink according to claim 1 which is used for ink jet recording.

7. An ink set for ink jet recording comprising two or more kinds of aqueous inks, wherein at least one kind of the inks is an aqueous ink according to claim 6.

8. An ink set for ink jet recording comprising two or more kinds of aqueous inks having different color inks from each other, wherein at least one kind of the inks is an aqueous ink according to claim 6.
